(19) United States
(12) Patent Application Publication
(10) Pub. No.: US 2013/0039838 A1
(43) Pub. Date: Feb. 14, 2013

(54) SYSTEMS AND METHODS FOR PRODUCTION OF NANOSTRUCTURES USING A PLASMA GENERATOR

(71) Applicants: David S. Lashmore, Lebanon, NH (US); Robert Dean, Norwich, VT (US)

(72) Inventors: David S. Lashmore, Lebanon, NH (US); Robert Dean, Norwich, VT (US)

(73) Assignee: Nanocomp Technologies, Inc., Concord, NH (US)

(21) Appl. No.: 13/560,582

(22) Filed: Jul. 27, 2012

Related U.S. Application Data
(63) Continuation-in-part of application No. 12/140,263, filed on Jun. 16, 2008.
(60) Provisional application No. 60/934,655, filed on Jun. 15, 2007.
(60) Provisional application No. 61/512,873, filed on Jul. 28, 2011.

(51) Int. Cl. D01F 9/12; B82Y 40/00; B82Y 30/00

(52) U.S. Cl. 423/447.1; 422/307; 977/742; 977/750; 977/752; 977/844

(57) ABSTRACT

The present disclosure provides systems and methods for production of nanostructures using a plasma generator. In an embodiment, a system for use with a reactor for synthesis of nanostructures may include a chamber defining a pathway for directing a fluid mixture for the synthesis of nanostructures through the chamber. The system may further include one or more heating zones disposed along the chamber to provide a temperature gradient in the chamber to form catalyst particles upon which nanostructures can be generated from the components of the fluid mixture. The system may also include a plasma generator for generating a plasma flame in a conduit through which the fluid mixture may be passed to decompose a carbon source in the fluid mixture into its constituent atoms before proceeding into the reactor for formation of nanostructures.

### RELATED U.S. APPLICATION(S)

The present application is a continuation in part application of U.S. application Ser. No. 12/140,263, filed on Jun. 16, 2008, which claims the benefit of and priority to U.S. Provisional Application Ser. No. 60/934,655, filed Jun. 15, 2007. The disclosures of these applications are hereby incorporated herein by reference in their entireties.

The present application also claims benefit of and priority to U.S. Provisional Application No. 61/512,973, filed Jul. 28, 2011, the disclosure of this application is hereby incorporated herein by reference in its entirety.

### GOVERNMENT SUPPORT

The invention is supported, in whole or in part, by the U.S. Government under contract Number: 000-11-C-0324. The Government may have certain rights in the invention.

### TECHNICAL FIELD

The present invention relates to systems for generating carbon nanostructures, and more particularly, to reactors having a plasma generator for optimizing growth conditions for the generation of carbon nanostructures.

### BACKGROUND ART

The production of long, substantially defect-free carbon nanotubes (CNTs) may be necessary to make usable materials that can retain the desirable properties of individual nanotubes. In general, nanotube growth may be limited by various growth conditions, including (1) fuel starvation, (2) catalyst size and stability, (3) carbon diffusion rates on the catalyst surfaces, (4) nature of the reaction gas, (5) duration within the reaction zone, and (6) temperature of the reaction zone.

It has been observed that nanotube growth seems to be non-linear with residence time within a reactor. In addition, it has been observed that larger catalysts tend to exhibit substantially no growth. To that end, termination of growth may be correlated to the change in the catalyst particle size during nanotube growth.

Optimization of growth parameters, including those indicated above, has recently led to a measurable increase in carbon nanotube production and strength of material made from these nanotubes. One primary parameter which appears to be related to strength is length of the nanotube. For example, long samples of yarns (i.e., intertwined or spun carbon nanotubes), some over about 10 meters in length, with a strength of over about 1.4 GPa have been produced. However, even at such length, there may still be about 5 to about 10 times less than the potential material strength of a yarn, when based on individual tube strength estimated at about 30 GPa. Creating longer individual nanotubes should translate into material strengths that more closely approach the average strength of individual nanotubes.

Accordingly, it would be desirable to provide a system and method capable of controlling specific parameters necessary for optimizing growth, as well as enhancing the strength of materials made from the nanotubes being produced.

### SUMMARY

The present disclosure provides systems and methods for production of nanostructures using a plasma generator. In an embodiment, a system for use with a reactor for synthesis of nanostructures may include a chamber defining a pathway for directing a fluid mixture for the synthesis of nanostructures through the chamber. The system may further include one or more heating zones disposed along the chamber to provide a temperature gradient in the chamber sufficient to permit the formation, from components within the fluid mixture, of catalyst particles upon which nanostructures can be generated. In some embodiments, the system also includes a plasma generator for generating a plasma flame in a conduit, the conduit having an inlet in fluid communication with the pathway of the chamber and an outlet in fluid communication with the reactor to pass the fluid mixture from the pathway, through the plasma flame to decompose a carbon source in the fluid mixture into its constituent atoms and into the reactor for formation of nanostructures.

In an embodiment, a method for producing nanostructures is provided. Such method may include passing a fluid mixture from which carbon nanostructures can be generated through a temperature gradient to initiate the carbon nanostructures generation process. Subsequently, the mixture may be directed through a plasma flame to elevate the mixture to a temperature range sufficient to decompose the carbon source in the mixture into its constituent atoms. In addition, the carbon atoms may be permitted to interact with the catalyst particles to allow growth of nanostructures on the catalyst particles.

In an embodiment, a system for synthesis of nanostructures includes a housing having opposite ends and a passageway extending between the ends. The system also includes a conduit having an inlet and an outlet, the outlet of the conduit being in fluid communication with a first end of the passageway. An injector may also be provided in the system for introducing a fluid mixture having a catalyst precursor and a carbon source into the inlet of the conduit, where the injector may have one or more heating zones along the injector to provide a temperature range sufficient to decompose catalyst precursor to form catalyst particles upon which nanostructures can be generated within the injector. The system may further include a plasma generator adapted to generate a plasma flame in the conduit to elevate the fluid mixture to a temperature range sufficient to decompose carbon source in the fluid mixture into its constituent atoms for formation of nanostructures on the catalyst particles. Synthesized nanostructures may be collected in a collector in communication with a second end of the housing.

### BRIEF DESCRIPTION OF DRAWINGS

FIG. 1A illustrates a schematic diagram of a CVD system for production of nanostructures in connection with an embodiment of the present invention.

FIG. 1B is a schematic illustration of an injector apparatus for use in connection with the CVD system shown in FIG. 1.

FIG. 1C illustrates a schematic diagram of a CVD system utilizing a plasma generator for production of nanostructures in connection with an embodiment of the present disclosure.

FIG. 1D illustrates a schematic diagram of an embodiment plasma generator suitable for use in connection with an embodiment of the present disclosure.

FIG. 2 illustrates yarn strength as a function of the thermal gradient near the end of the injector.

FIG. 3 illustrates yarn strength as a function of Tex for different fuel types.

FIG. 4 illustrates Raman data on the intensity of RBM/G band as a function of one of the fuel additives.

FIG. 5 illustrates a comparison of Raman spectra for two different thiophene concentrations.

FIG. 6 illustrates the effect of additives to the fuel on the RMBs and D/G ratios.

FIG. 7 illustrates the effect of hydrogen flow through the nebulizer on the radial breathing mode presence measured in percentage of the G band intensity.

FIG. 8 illustrates the effect of hydrogen flow through the nebulizer on the RBMs for different entrance tube diameters.

FIG. 9A illustrates a Raman spectra of a fully optimized system.

FIG. 9B illustrates an RBM region of the Raman spectra, specifically a histogram of the diameter distribution.

FIG. 10 illustrates an SEM micrograph of optimized growth showing spontaneous alignment of the tubes and a clean microstructure.

FIG. 11 illustrates a TEM micrograph showing very small tubes, ropes made of small tubes, larger single wall carbon nanotubes and an average amount of catalyst, and a minimal amount of amorphous carbon.

FIG. 12 illustrates a histogram of nanotube diameters measured from the TEM fitted to a normalized distribution.

### DESCRIPTION OF SPECIFIC EMBODIMENTS

Nanotubes for use in connection with the present invention may be fabricated using a variety of approaches. Presently, there exist multiple processes and variations thereof for growing nanotubes. These include: (1) Chemical Vapor Deposition (CVD), a common process that can occur at near ambient or at high pressures, and at temperatures above about 400° C., (2) Arc Discharge, a high temperature process that can give rise to tubes having a high degree of perfection, and (3) Laser ablation. It should be noted that although reference is made below to nanotube synthesized from carbon, other compound(s) may be used in connection with the synthesis of nanotubes for use with the present invention. Other methods, such as plasma CVD or the like are also possible. It is understood that boron nanotubes may also be growth in a similar system but with different chemical precursors.

The present invention, in one embodiment, employs a CVD process or similar gas phase pyrolysis procedures known in the industry to generate the appropriate nanostructures, including nanotubes. In particular, since growth temperatures for CVD can be comparatively low ranging, for instance, from about 400° C. to about 1400° C., carbon nanotubes, both single wall (SWNT) or multiwall (MWNT), may be grown. These carbon nanotubes may be grown, in an embodiment, from nanostructural catalyst particles introduced into reagent carbon-containing gases (i.e., gaseous carbon source), either by addition of existing particles or by in situ synthesis of the particles from, for instance, a metal-organic precursor, or even non-metallic catalysts. Although both SWNT and MWNT may be grown, in certain instances, SWNT may be preferred because of their higher growth rate and tendency to form ropes which may offer handling, safety and strength advantages.

The strength of the individual SWNT and MWNT generated for use in connection with the present invention may be about 30 GPa or more. Strength, as should be noted, can be sensitive to defects. However, the elastic modulus of the SWNT and MWNT fabricated for use with the present invention is typically not sensitive to defects and can vary from about 1 to about 1.2 TPa. Moreover, the strain to failure, which generally can be a structure sensitive parameter, may range from a few percent to a maximum of about 12% in the present invention.

Furthermore, the nanotubes of the present invention can be provided with relatively small diameter, so that relatively high capacitance can be generated. In an embodiment of the present invention, the nanotubes of the present invention can be provided with a diameter in a range of from less than 1 nm to about 10 nm. It should be appreciated that the smaller the diameter of the nanotubes, the higher the surface area per gram of nanotubes can be provided, and thus the higher the capacitance that can be generated. For example, assuming a 50 micro-Farads per cm capacitance for graphene and a density of about 1.5 g/cc for the SWNT, capacitance can be calculated using the following formula:

Capacitance(Farads/gram)=1333/d(nm)

Therefore, assuming a uniform textile of 1 nm diameter tubes with no shielding, then a specific capacitance of 1333 Farads per gram should be feasible, neglecting the loss in surface area when ropes are formed and neglecting the loss of active area for the nanotubes that are shielded by their neighbors.

Since many important properties of carbon nanotubes (CNT) depend on diameter, including the growth rate, focusing on relatively small diameter catalyst particles can result in carbon nanotubes with correspondingly small diameters.

To do so, in one embodiment of the present invention, a diode laser Raman spectrometer was used to enhance the study and understanding of CNT growth parameter and the effects on the resulting structure. In general, three measures of quality were used, including: (1) the existence of Radial Breathing Modes (RBM), particularly those of smaller diameter, (2) the intensity of these modes relative to G Band (i.e., Graphene peak), and (3) the ratio of the D Band to the G Band (i.e., Disorder peak (˜1300 cm-1) to the Graphene peak (1580 cm-1)).

It should be noted that a smaller D/G can indicate relatively fewer sp³ bonds, and therefore fewer defects. Typically the D Band (sp³) can be a result of amorphous carbon, though it could also suggest defects in the tubes. The intensity of the Radial Breathing Modes (RBMs) relative to the G band, on the other hand, can be indicative of the relative amount of Single Walled Nanotubes (SWNTs) in the sample, while the relative intensities of the various RBMs can give an indication of the diameter distribution of the tubes. These considerations, in conjunction with, for example, Transmission Electron Microscopy (TEM) and tensile testing, as provided hereinafter in detail, have allowed for optimization of the manufacturing process of the present invention, which resulted in relatively stronger and longer carbon nanostructures, such as carbon nanotubes (CNTs).

As noted above, one parameter which may have a direct affect on strength of the carbone nanostructures can be the length of the carbon nanotubes. Other parameters have also been examined to determine whether they can assist in providing an efficient growth model for carbon nanostructures. For example, in one approach, using the intensity of the RBM relative to the G band as a guide, a parameter space associated with each furnace, used in connection with the system of the present invention, can be explored quantitatively.

In connection with the present invention, there can be over a dozen different parameters, many of which interact with one another, and many of which may need to be simultaneously optimized for each furnace. Traditionally, to optimize these systems, unless timely and quantitative feedback can be provided, the optimization process can be difficult. However, by observing how the parameters being studied interact and produce changes, for instances, in a Raman spectra, in conjunction with Strength, Efficiency, and TEM/SEM data, a fundamental understanding of the carbon nanostructure growth in the system of the present invention has been established, resulting in an efficient model for the growth of such nanostructures in the system of the present invention.

### The System

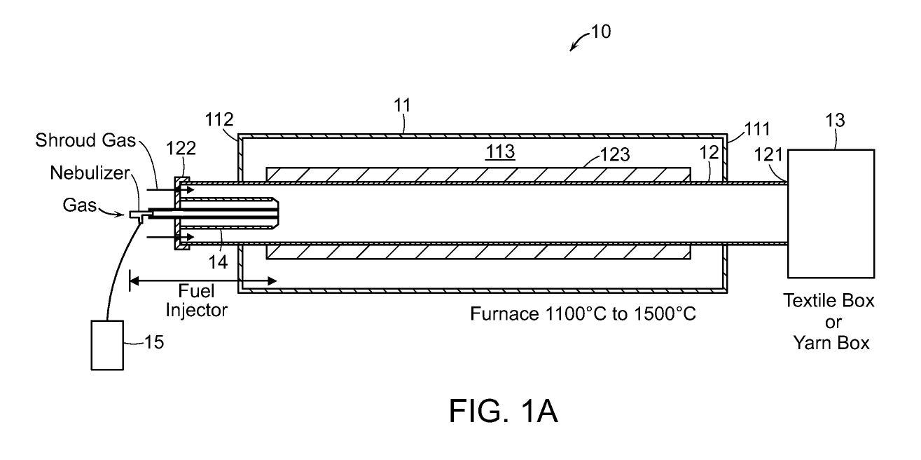

In connection with the following experiments, a system similar to that illustrated in FIG. 1A may be employed to analyze the various parameters and subsequently optimize an efficient model for the growth of carbon nanostructures.

System 10, as illustrated in FIG. 1A, includes, in one embodiment, includes housing 11 (i.e., furnace) having opposite ends 111 and 112, and a passageway 113 extending between ends 111 and 112. A tube 12 (i.e., reactor) within which extended length nanostructures may be generated, may be situated within the passageway 113 of housing 11. As shown in FIG. 1A, ends 121 and 122 of tube 12 may be positioned so that they extend from ends 111 and 112 respectively of housing 11. Housing 11, in an embodiment, may including heating elements or mechanisms (not shown) to generate temperature ranging up to from about 1100° C. to about 1500° C., necessary for the growth of carbon nanostructures within tube 12. As the heating elements must maintain the temperature environment within tube 12 to within a specified range during the synthesis of the extended length nanostructures, although not illustrated, the system 10 may be provided with a thermocouple on the exterior of tube 12 to monitor the temperature environment within tube 12. In an embodiment, the maintenance of the temperature range within tube 12, e.g., from about 1000° C. to about 1400° C., may be optimized by the use of an insulating structure 123. Insulating structure 123, in one embodiment, may be made from, for example, zirconia ceramic fibers (e.g., zirconia-stabilized boron nitride). Other insulating materials may, of course, also be used.

As the housing 11 and tube 12 must withstand variations in temperature and gas-reactive environments, housing 11 and tube 12 may be manufactured from a strong, substantially gas-impermeable material that is substantially resistant to corrosion. In an embodiment, the housing 11 and tube 12 may be made from a quartz material. In an embodiment, the housing 11 and tube 12 may be made from a ceramic material, such as, for example, Macor® machinable glass ceramic, to provide enhanced shock absorption. Of course, other materials may be used, so long as the housing 11 and tube 12 can remain impermeable to gas and maintain their non-corrosive character. Also, although illustrated as being cylindrical in shape, housing 11 and tube 12 may be provided with any geometric cross-section.

System 10 may also include a collection unit 13 in fluid communication with end 121 of tube 12 for collecting nanostructures generated from within tube 12. At opposite 122 of tube 12, system 10 may include an injector apparatus 14 (i.e., nebulizer) in fluid communication with tube 12. Injector 14, in an embodiment, may be designed to receive from a reservoir 15 a fluid mixture of components necessary for the growth of nanostructures within tube 12. Injector 14 may also be designed to vaporize or fluidize the mixture (i.e., generating small droplets) before directing the mixture into tube 12 for the generation and growth of nanostructures.

The fluid mixture, in one embodiment, can include, among other things, (a) a catalyst precursor from which a catalyst particle can be generated for subsequent growth of the nanostructure thereon, (b) a conditioner compound for controlling size distribution of catalyst particles generated from the catalyst precursor, and thus the diameter of the nanostructure, and (c) a carbon source for depositing carbon atoms onto the catalyst particle in order to grow the nanostructures.

Examples of a catalyst precursor from which catalyst particles may be generated includes Ferrocene, materials such as iron, iron alloy, nickel or cobalt, their oxides, or their alloys (or compounds with other metals or ceramics). Alternatively, the catalyst particles may be made from metal oxides, such as Fe₃O₄, Fe₂O₄, or FeO, or similar oxides of cobalt or nickel, or a combination thereof.

Examples of a conditioner compound for use in connection with the fluid mixture of the present invention include Thiophene, H₂S, other sulfur containing compounds, or a combination thereof.

Examples of a carbon source for use in connection with the fluid mixture of the present invention include, but not limited to, ethanol, methyl formate, propanol, acetic acid, hexane, methanol, or blends of methanol with ethanol. Other liquid carbon source may also be used, including C₂H₂, CH₃, and CH₄.

Looking now at FIG. 1B, there is shown a detail illustration of injector 14. Injector 14, in one embodiment, includes a substantially tubular chamber 141 defining a pathway 142 along which the vaporized fluid mixture may be generated and directed into reactor tube 12. To vaporize or fluidize the mixture, injector 14 may include a nebulizing tube 16 designed to impart a venturi effect in order to generate small droplets from the fluid mixture being introduced from reservoir 15. It should be appreciated that, in one embodiment, the vaporizing or fluidizing of the fluid mixture occurs substantially as the fluid exits through distal end 161 of nebulizing tube 16. In an embodiment, the droplets being generated may range from nanoscale in size to microscale in size. To direct the vaporized fluid mixture along the nebulizing tube 16 into the reactor tube 12, in one embodiment, a volume of gas, such as H₂, He or any other inert gases, may be used to push the vaporized fluid toward the reactor tube 12.

Although illustrated as substantially tubular, it should be appreciated that injector 14 may be provided with any geometric designs, so long as the injector can accommodate the nebulizing tube 16, and provide a pathway along which the vaporized fluid mixture can be directed into a reactor tube 12.

In addition, it should be noted that the injector 14 of the present invention may be designed to permit introduction of individual components of the fluid mixture into the injector 14 rather than providing them as part of the fluid mixture. In such an embodiment, each component may be individually vaporized, through a nebulizing tube similar to tube 16, and introduced into the injector 14, where they may be allowed to mix and subsequently directed along the injector 14 in a similar manner to that described above.

As injector 14 is situated within a portion of reactor tube 12 and furnace 11, the heat being generated within tube 12 and furnace 11 may have a negative affect on the temperature environment within injector 14. In order to shield injector 14 from the heat in reactor tube 12 and furnace 11, an insulation package 17 may be provided about injector 14. In particular, insulation package 17 may act to preserve the temperature environment along the length of injector 14.

With the presence of insulation package 17, the temperature environment within injector 14 may be lowered to a range which can affect the various reactions necessary for growing nanostructures. To that end, injector 14 may also include a heating zone A situated downstream from the nebulizing tube 16 to provide a temperature range sufficient to permit the formation of catalyst particles from the catalyst precursors. In one embodiment, the heating zone A includes a first heater 18 situated downstream of the distal end 161 of nebulizing tube 16. Heater 18 may be provided to maintain a temperature range at, for instance, Tp1 necessary to decompose the catalyst precursor into its constituent atoms, and which atoms may thereafter cluster into catalyst particles on which nanostructures may subsequently be grown. In order to maintain the temperature range at Tp1 at a level necessary to decompose the catalyst precursor, heater 18, in one embodiment, may be situated slightly downstream of Tp1. In an embodiment where Ferrocene is used as a precursor, its constituent atoms (i.e., iron particles), substantially nanoscaled in size, may be generated when the temperature at Tp1 can be maintained in a range of from about 200° C. to about 300° C.

Heating zone A may further include a second heater 19 positioned downstream of first heater 18, and within furnace 11. Heater 19 may be provided to maintain a temperature range at, for example, Tp2 necessary to decompose the conditioner compound into its constituent atoms. These atoms, in the presence of the clusters of catalyst particles, can interact with the clusters to control the size distribution of the catalyst particles, and hence the diameter of the nanostructures being generated. In an embodiment wherein Thiophene is used as a conditioning compound, sulfur may be released upon decomposition of the Thiophene to interact with the clusters of catalyst particles. Heater 19, in an embodiment, may be designed to maintain a temperature range at Tp2 from about 700° C. to about 950° C. and to maintain such a range at a location slightly downstream of the heater 19.

In accordance with one embodiment of the present invention, Tp2 may be may be located at a desired distance from Tp1. As various parameters can be come into play, the distance from Tp1 to Tp2 should be such that the flow of fluid mixture from Tp1, where decomposition of the catalyst precursor occurs, to Tp2 can optimize the amount of decomposition of the conditioning compound, in order to optimize the size distribution of the catalyst particles.

It should be appreciated that in addition to the particular temperature zones generated by first heater 18 and second heater 19 within injector 14, the temperature at the distal end 161 of nebulizing tube 16 may also need to be maintained within a particular range in the injector 14 in order to avoid either condensation of the vaporized fluid mixture or uneven flow of the fluid mixture as it exits through distal end 161 of nebulizing tube 16. In an embodiment, the temperature at the distal end 161 may need to be maintained between about 100° C. and about 250° C. If, for example, the temperature is below the indicated range, condensation of the fluid mixture may occur along a wall surface of the injector 16. Consequently, the fluid mixture that is directed from the injector 16 into the reactor tube 12 may be substantially different from that of the mixture introduced from reservoir 15. If, for example, the temperature is above the indicated range, boiling of the fluid mixture may occur at the distal end 161, resulting in sputtering and uneven flow of the fluid into the injector 14.

As injector 14 may need to maintain a temperature gradient along its length, whether to minimize condensation of the distal end 161 of the nebulizing tube 16, to maintain the necessary temperature at Tp1 to permit decomposition of the catalyst precursor, or at Tp2 to permit decomposition of the conditioning compound, insulation package 17, in addition to shielding heat from the reactor tube 12 and furnace 11, can act to maintain the desired temperature gradient along injector 14 at each critical location.

In one embodiment, the insulation package 17 may be made from quartz or similar materials, or from a porous ceramic material, such as zirconia ceramic fibers (e.g., zirconia-stabilized boron nitride). Other insulating materials may, of course, also be used.

Still looking at FIG. 1B, system 10 may include at least one inlet 191 through which a carrier gas may be introduced into reactor tube 12. The introduction of a carrier gas into tube 12 may assist in moving the fluid mixture along tube 12 subsequent to its exit from injector 14. In addition, as it may be desirable to minimize turbulent flow or vortex flow associated with the fluid mixture as it exits injector 14, the carrier gas may be permitted to flow along the reactor tube 12 and along an exterior surface of injector 14. In an embodiment the carrier gas may be permitted to flow at a speed substantially similar to that of the fluid mixture, as the mixture exits the injector 14, to permit the fluid mixture to maintain a substantially laminar flow. By maintaining a substantially laminar flow, growth and strength of the nanostructures being produced may be optimized. In an embodiment, the carrier gas may be H₂, He or any other inert gases.

To further minimize turbulent flow or vortex flow as the fluid mixture exits the injector 14, insulation package 17 may be provided with a substantially tapered design about distal end of injector 14. Alternatively or in addition, an extension (not shown) may be situated about distal end of injector 14 to expand the flow of the fluid mixture substantially radially away from the center of the injector 14 as the fluid mixture exits the distal end of the injector. The presence of such an extension can slow down flow velocity of the fluid mixture and allow the flow pattern to remain substantially laminar.

It should be appreciated that the injector 14 may be designed to decompose the catalyst precursor at Tp1 and the conditioning compound at Tp2 as the fluid mixture moves along injector 14. However, the carbon source necessary for nanostructure growth does not get decomposed and may remain substantially chemically unchanged as the fluid mixture moves along injector 14.

However, since the distal end of injector 14 protrudes into furnace 11, as seen in FIGS. 1A-B, its proximity to a substantially higher temperature range within the furnace 11, and thus reactor tube 12, can expose the carbon source immediately to a temperature range necessary to decompose the carbon source, upon its exiting through the distal end of the injector 14, for subsequent nanostructure growth. In an embodiment, the temperature range at interface 142 between distal end of the injector and furnace 11 may be from about 1000° C. to about 1250° C.

In reference to FIG. 1C, in an embodiment, a plasma generator 130 may be disposed about the distal end of the injector 14. In this manner, the fluid mixture may be passed through a plasma flame 132 of the plasma generator 130 before entering the reactor tube 12. In an embodiment, there may be provided hermetic seals or fluid tight seals around the junctions between the plasma generator 130 and the injector 14, as well as between the plasma generator 130 and the reactor tube 12 to prevent gases and particles in the fluid mixture from escaping from the system 10. In one embodiment, the plasma generator 130 may be in a axial or linear alignment with the tubular chamber 141 of the injector 14 to provide an efficient flow path for the fluid mixture from the injector 14 and through the plasma generator 130. In an embodiment, the alignment of the plasma generator 130 with the injector 14 is such that the fluid mixture is allowed to pass substantially through the middle of the plasma generator 130. In some embodiments, this may lead to the fluid mixture passing through the middle region of the plasma flame 132, which may have a more uniform temperature profile than the outer regions of the plasma flame 130. The plasma generator 130 may also be in a axial or linear alignment with the reactor tube 12.

In an embodiment, the plasma generator 130 may provide concentrated energy, in the form of the plasma flame 132, to increase the temperature of the fluid mixture to a temperature higher than the temperature range in the injector 14. In an embodiment, the plasma generator 130 can increase the temperature of the fluid mixture to a level sufficient to decompose the carbon source into its constituent atoms for activation of nanostructure growth. In an embodiment, the plasma generator 130 may operate between about 1200° C. and about 1700° C. Because the temperature of the plasma flame 132 is substantially higher than the temperature in the injector 14, the heat generated by the plasma flame 132 may have a negative affect on the temperature environment within the injector 14. To that end, the plasma generator may be provided with a heat shield 160 situated between the region of the plasma generator 130 where the plasma flame 132 is generated and the injector 14 to preserve the temperature environment along the length of injector 14. In one embodiment, the heat shield 160 may be made from a porous ceramic material, such as zirconia ceramic fibers (e.g., zirconia-stabilized boron nitride). Other insulating materials may, of course, also be used.

Because the plasma generator 130 may provide concentrated energy to the fluid mixture thereby initiating quicker decomposition of the carbon source, in one embodiment, a shorter reactor tube 12, the furnace 11 or both may be used and still generate nanotubes of sufficient length. Of course to the extent desired, reactor tube 12, the furnace 11 or both may be provided with a similar or longer lengths than in systems without a plasma generator. In an embodiment, utilizing the plasma generator 130 in the process may enable production of longer nanotubes.

It should also be noted that in some embodiments, the injector 14 and plasma generator 130 may be utilized with minimal or without additional heat in the reaction tube 12. It should also be noted that multiple plasma generators may be utilized in the system 10 to provide a desired temperature gradient over a travel distance of the fluid mixture.

FIG. 1D illustrates one suitable embodiment of the plasma generator 130. In an embodiment, the plasma generator 130 may be a direct current (DC) power generator. The plasma generator 130 may include an anode 152 and a cathode 154, which can be cooled by water or another cooling fluid or another material that may act as a heat sink to transfer the heat away from the electrodes 152, 154. In an embodiment, the electrodes 152, 154 may be high diffusivity-metal electrodes, such as typically made of copper or silver. Plasma gas may flow around the anode 152 and cathode 154 and may be ionized by an electric arc 156 initiated between the anode 152 and cathode 154 to create plasma flame 132. Suitable plasma gasses may be either reactive or non-reactive and may include, but are not limited, argon oxygen, nitrogen, helium, hydrogen or another gas. In an embodiment, the plasma generator 130 may include one or more Helmholts coils 158 or another device for producing magnetic field for rotating the arc 156. In such an embodiment, the anode 152 and cathode 154 may be provided with an annular shape to facilitate rotation of the arc 156. While FIG. 1D illustrates one suitable embodiment of a plasma generator, other designs and types of plasma generators (i.e. radio frequency, alternating current and other discharges plasma generators) may be implemented.

In an embodiment, the Helmholts coils 158 can be used to generate an electromagnetic or electrostatic field for in situ alignment of the nanotubes downstream of the plasma generator 130 in the reactor chamber 12. Additionally or alternatively, the electromagnetic field created by the plasma generator 130 can act to deflect the carbon nanotubes towards the axis of the reaction tube 12 by generating a torque on the carbon nanotubes, packing the carbon nanotubes towards such axis. In an embodiment the plasma generator 130 can also be designed to push or focus the cloud of carbon nanotubes into a smaller radial volume as the cloud of carbon nanobtubes proceeds through the reaction tube 12. In an embodiment, particles from which CNTs grow can be charged by a particle charger so that the particles can respond to electrostatic forces.

To the extent more than one plasma generator 130 is used, the plasma generators field strength and position can be optimized to align the CNTs. Additionally or alternatively, the power generators may be in linear alignment with one another, and each successive downstream plasma generator may be configured to generate a stronger electrostatic field, so as to force or condense the flowing cloud of CNTs toward a smaller radial volume, while moving the CNTs in a substantial axial alignment with the reaction tube 12. In some embodiments, the successive plasma generators can also be used to control the flow acceleration or deceleration, allowing the nanotubes to radially condense toward a filament like shape. Such an approach toward condensing the flow of CNTs can force the CNTs to be in closer proximity to enhance contact between adjacent nanotubes. Contacts between adjacent CNTs can be further enhanced via non-covalent interactions between the CNTs, such as London dispersion forces or van der Waals forces. By way of a non-limiting example, additional suitable systems and methods for aligning and packing CNTs are disclosed in a co-pending, commonly owned PCT application to Lashmore et at., entitled “SYSTEMS AND METHODS FOR NANOSCOPICALLY ALIGNED CARBON NANOTUBES” and filed on Jul. 27, 2012, incorporated herein by reference in its entirety.

### Process

Using the system 10 and injector 14, as illustrated in FIGS. 1A-B, a variety of parameters were examined. In one approach, two sets of parameters were initially examined: (1) the fluid mixture, including the catalyst precursor, the conditioning compound, and the carbon source, which can affect nanostructure growth in a variety of ways, and (2) temperature and geometrical parameters characterizing the injection 14 of the system 10.

Fluid mixture parameters, in an embodiment, can involve a) concentrations of each of the components of the mixtures, including any additives, as well as b) Injection Rate (IR) of the fluid mixture into the system 10. Additional parameters can include flow rates of, for example, H₂ or He along the nebulizing tube 16 into the injector 14, as well as the flow rates carrier gas H₂ or He into a in the reactor tube 12 surrounding the injector 14.

As for parameters associated with the injector 14 that may affect nanostructure growth, they include the internal diameter (ID) of injector 14, length (L) of injector 14, the distance (Z) from furnace 11 where a nebulizing tube 16 is located, as well as Tp1 and Tp2 the temperatures at two different locations in the injector 14. Moreover, the presence or absence of insulation package 17 around the injector 14 can also be an important variable. It has been noted that these and other parameters that can affect the thermal profile of the injector 14 of system 10 can be critical to the quality and quantity of CNT production. Other parameters that can affect the thermal profile of the injector 14 of the system 10 are provided in Table 1 below, including various parameters associated with collection and spinning of the nanostructures, such as carbon nanotubes.

TABLE 1

| Parameter | [Ferr] | [Thio] | [VC] | IR | H_{R} | He_{R} | H_{S} |
|---|---|---|---|---|---|---|---|
| Effect | Catalyst | Catalyst | ? | Catalyst | Catalyst | Catalyst | Nanotube |
| | Quantity | Activation | | Quantity | Size | Size | Quality |
| Interaction | IR Hr | [Ferr]? | [Ferr]? | [Ferr] Hr | [Ferr] IR | ID Tp? | [Ferr] IR |
| | Hs | [VC]? | [Thio]? | Hs | Hs | | Hr |

| Parameter | T_{F} | T_{P1} T_{P2} | Z | L_{P} | ID_{P} | Insulation |
|---|---|---|---|---|---|---|
| Effect | Growth | Catalyst | Catalyst | Catalyst | Catalyst | Catalyst |
| | Kinetics | Size | Size | Size | Size | Size |
| Interaction | Hr + Hs | Z L ID Hr | Tp Lp | Tp Z Tf | Tp Hr | Tp Hr |
| | | He | Hr He | Hr Ins | | |
| | | | Tf Ins | | | |

In general, a number of processes may be occurring in a region between the nebulizing tube 16 and the main furnace 11 of system 10. For instance, initially, the fluid mixture of catalyst precursor, conditioning compound and carbon source may be introduced from reservoir 15 into injector 14 by way of nebulizing tube 16. To assist in directing the mixture along the nebulizing tube 16, an inert gas, such as H₂ or He may be used. As the fluid mixture moves along the nebulizing tube 16 and exit therefrom, tube 16 can impart a venturi effect to vaporize the fluid mixture (i.e., generate droplets from the fluid mixture). To minimize any occurrences of condensation or boiling as the fluid mixture exits the nebulizing tube 16, such an area within the injector 14 may be maintained at a temperature level ranging from about 100° C. to about 250° C.

In an embodiment, an additive for the carbon source may be included in the fluid mixture to optimize growth conditions, as well as enhancing the strength of materials made from the nanotubes being produced. Examples of an additive includes C₆₀, C₇₀, C₇₂, C₈₄, and C₁₀₀.

The vaporized fluid mixture may then proceed along the injector 14 toward the first heater 18 where the temperature may be maintained at Tp1 at level ranging from about 200° C. to about 300° C., the catalyst precursor within the fluid mixture may be decomposed, releasing its constituent atoms. The decomposition temperature of the catalyst precursor, in an embodiment, can be dependent on the carrier gas (e.g., H₂ or He), and may depend on the presence of other species. The constituent atoms may subsequently cluster into catalyst particles of a characteristic size distribution. This size distribution of the catalyst particles can, in general, evolve during migration through the injector 14 and into the furnace 11.

Next, the fluid mixture may proceed further downstream along the injector 14 toward the second heater 19. The second heater 19, in an embodiment, may maintain the temperature at Tp2 at a level ranging from about 700° C. to about 950° C. where the conditioning compound may decompose into its constituent atoms. The constituent atoms of the conditioning compound may then react with the clusters of catalyst particles to effectuate the size distribution of the clusters of catalyst particles. In particular, the constituent atoms of the conditioning compound can act to stop the growth and/or inhibit evaporation of the catalyst particles. In an embodiment, the constituent atoms of the conditioning compounds along with H₂ in the injector 14 may interact with the clusters of catalyst particles to affect size distribution of the catalyst particles.

As will be seen by the Experiments provided below, the thermal profile, as well as the concentration profiles of various species can affect the size and stability of the catalyst particles, and therefore the growth of the nanostructures. In addition, the specific size distribution of the clusters of catalyst particles can also be determined by residence time in the injector 14, and the ID of the injector 14.

It should be appreciated that the carbon source within the fluid mixture may remain chemically unchanged or otherwise not decomposed within injector 14, as the fluid mixture travels along the entire length of the injector 14.

The conditioned catalyst particles once moved beyond the second heater 19, may thereafter move across interface 142 between distal end 141 of injector 14 and furnace 11 to enter into the main portion of reactor tube 12. Upon exiting the injector 14, the conditioned catalyst particles, along with the carbon source, may maintain a substantially laminar flow in the presence of a carrier gas, such as H₂ or He. In the presence of the carrier gas, the conditioned catalyst particles may be diluted by the volume of carrier gas.

In addition, upon entry into the main portion of the reactor tube 12, where the temperature range within the reactor tube 12 may be maintained at a level sufficient to decompose the carbon source into its constituent carbon atoms, the presence of the carbon atoms can activate nanostructure growth. In an embodiment, the temperature range may be from about 1000° C. to about 1250° C. In general, growth occurs when the carbon atoms attach themselves substantially sequentially upon the catalyst particles to form a nanostructure, such as a carbon nanotube.

In an embodiment, the fluid mixture from the injector 14 may be passed through the plasma generator 130 before entering the reactor tube 12.

Growth of the nanostructures may end when the catalyst particles become inactive, the concentration of constituent carbon atoms near the catalyst particles is reduced to a relatively low value, or the temperature drops as the mixture moves beyond an area within the reactor tube 12 where the temperature range is maintained at a sufficient level for growth.

### Experiment I

In one embodiment, the nature of the injector geometry, as well as the complex interaction of parameters can affect the strength and production efficiency of the nanostructures. In this experiment, yarn strength was monitored as a function of the thermal gradient at Tp2 and Tp1 (near the exit of the injector) for various concentrations of Ferrocene and Thiophene.

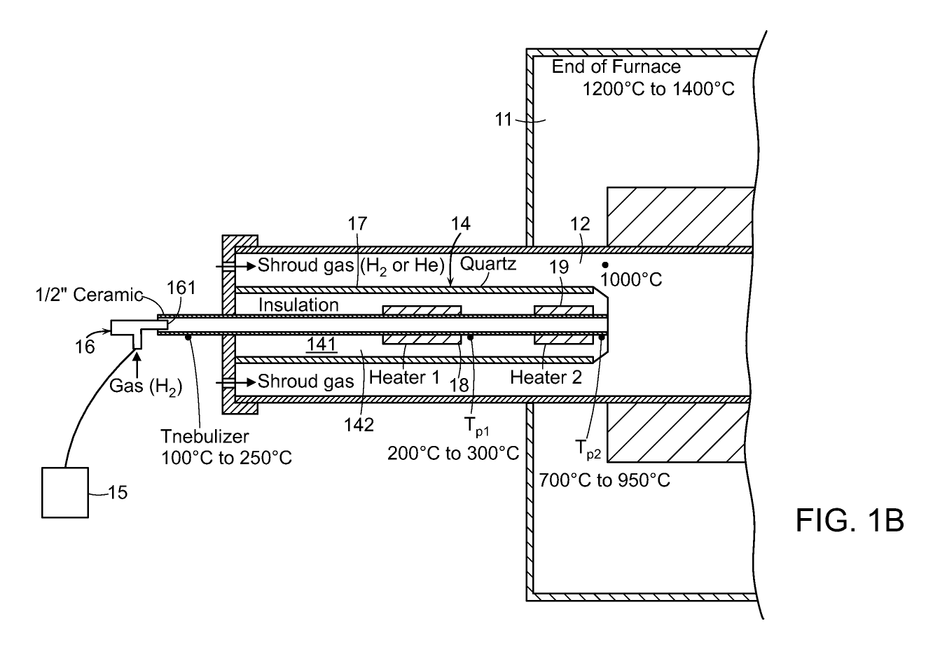

The results obtained for yarn strength as a function of thermal gradient are illustrated in FIG. 2. In particular, FIG. 2 shows a maximum in yarn strength as the injector thermal gradient is varied. Under lower than optimal thermal gradient conditions, there may be more time for the iron atoms generated by the decomposition of ferrocene to cluster before the clustering process is arrested by the sulfur provided by the decomposition of thiophene. This results in a larger diameter catalyst particles, which produces larger diameter and multi-walled nanotubes. The larger diameter tubes tend to be shorter, and therefore result in less-strong material. On the other hand, at larger than optimal thermal gradients there is insufficient time to cluster adequate catalyst particles in the injector (i.e., only small inadequate clusters), and the clustering process may need continue in the furnace region, where conditions are less controlled. Since there is substantially no clustering of catalyst particles in the injector, substantially no tubes are formed.

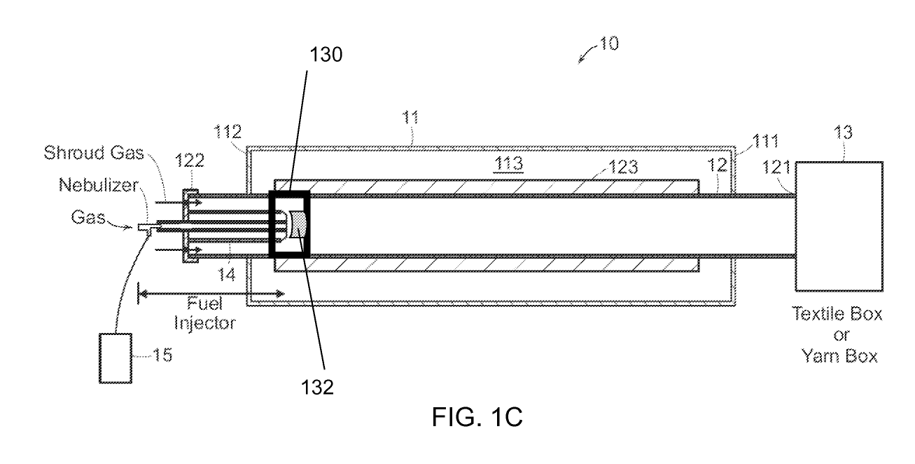

It should be noted that the strength of yarn samples is strongly dependent on the size of the yarn, expressed as the TEX value given in grams per kilometer. FIG. 3 shows a plot of yarn strength vs. TEX and illustrates that smaller TEX yarns are stronger. Correcting for different TEX samples shows that small changes in Ferrocene and Thiophene concentrations, without adjusting other parameters, do not have a significant effect on yarn strength.

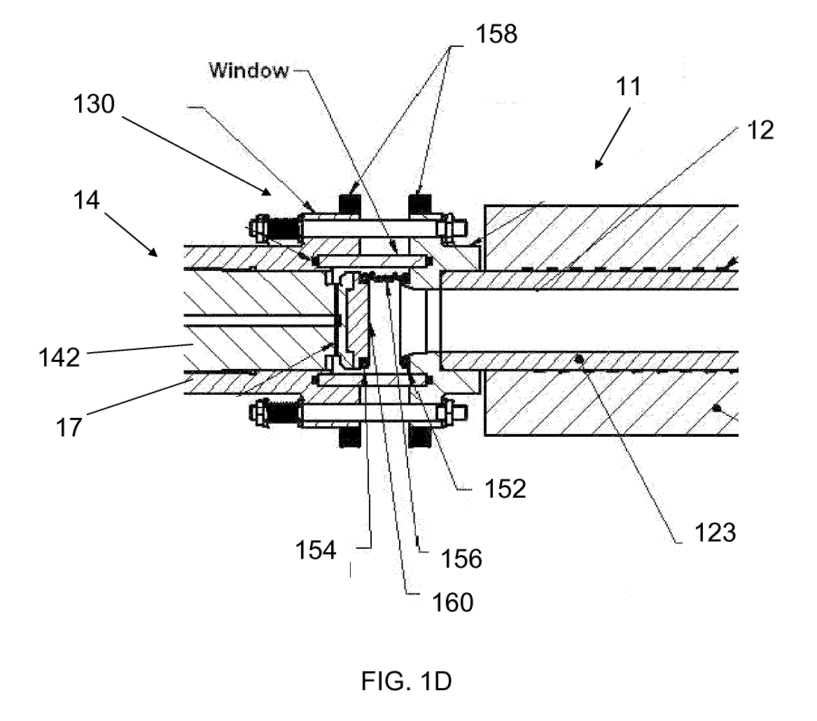

On the other hand, Raman data, as illustrated in FIG. 4, show a dramatic change in the quality of the nanotubes as the Thiophene concentration is changed. Decreasing the Thiophene concentration increases significantly the RBM/G ratio. However, efficiency decreases with decreasing Thiophene. A good compromise between quality and quantity of CNT's seems to be at about 0.3% Thiophene. This also corresponds to a minimum in the D/G ratio.

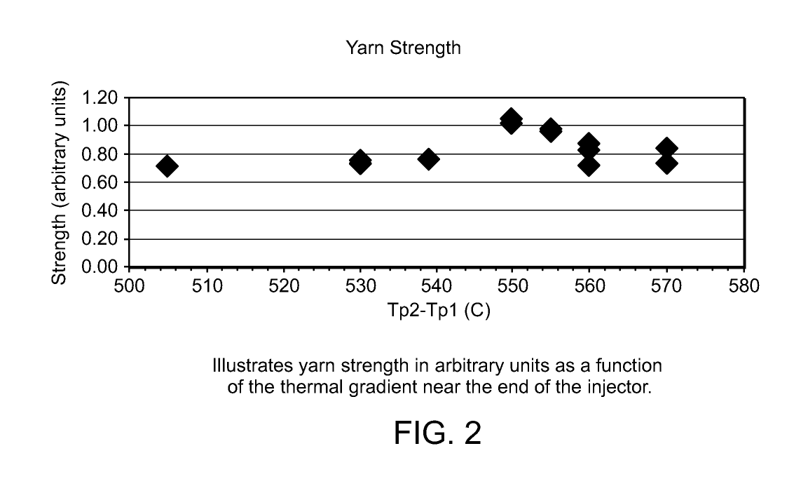

With reference now to FIG. 5, a comparison of the Raman spectra for two different thiophene concentrations is illustrated. Note the similar D/G ratios but substantially different SWCNT concentrations, as evidenced by the large intensity radial breathing modes between 200 and 800 wave numbers.

### Experiment II

In this experiment, carbon source additives were used. Examples of additives include C₆₀, C₇₀, C₇₂, C₈₄, and C₁₀₀. At a particular concentration, it was observed that the additives can enhance the catalyst nucleation and growth of the carbon nanotubes.

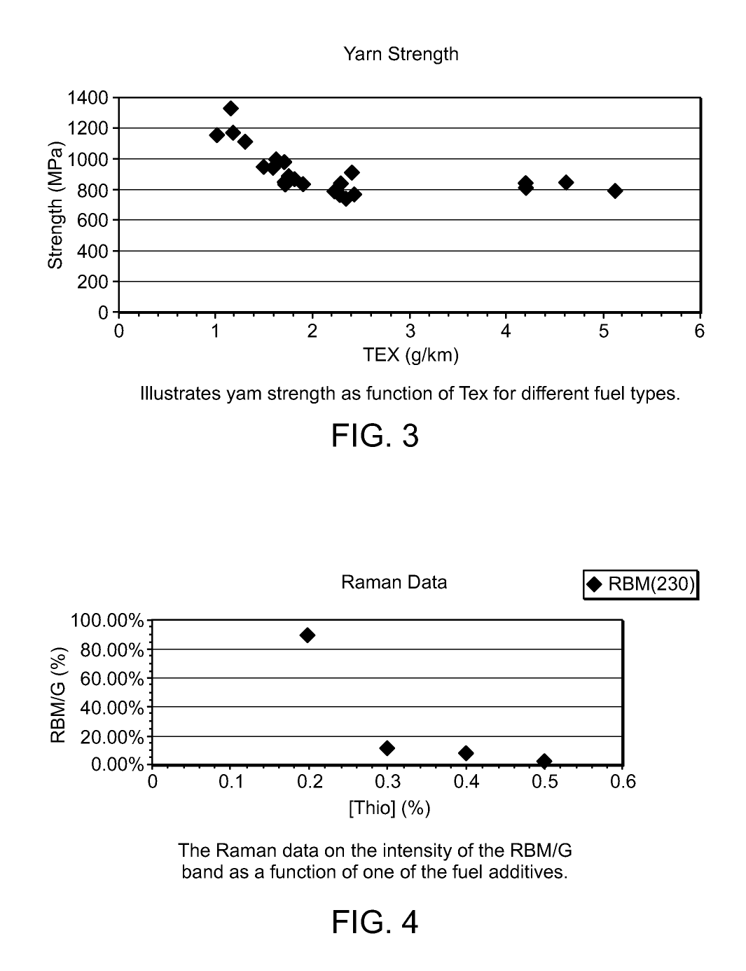

As can be seen in FIG. 6, when a carbon source additive is used, it can have a measurable effect on the RMB (radial breathing modes)/G ratio and the D/G ratio. Of interest, it does not appear that the amount of amorphous carbon is much affected. However, the presence of the carbon source additive can dramatically affect the catalyst nucleation and growth.

In one embodiment, a concentration of a carbon additive at about 0.75 ppm appears to be optimal, as measured by the RBM/G ratio.

### Experiment III

In this experiment, the flow of Hydrogen (H₂) through the injector 14 was studied to determine whether such flow can be optimized to enhance growth and production efficiency in system 10 of the present invention.

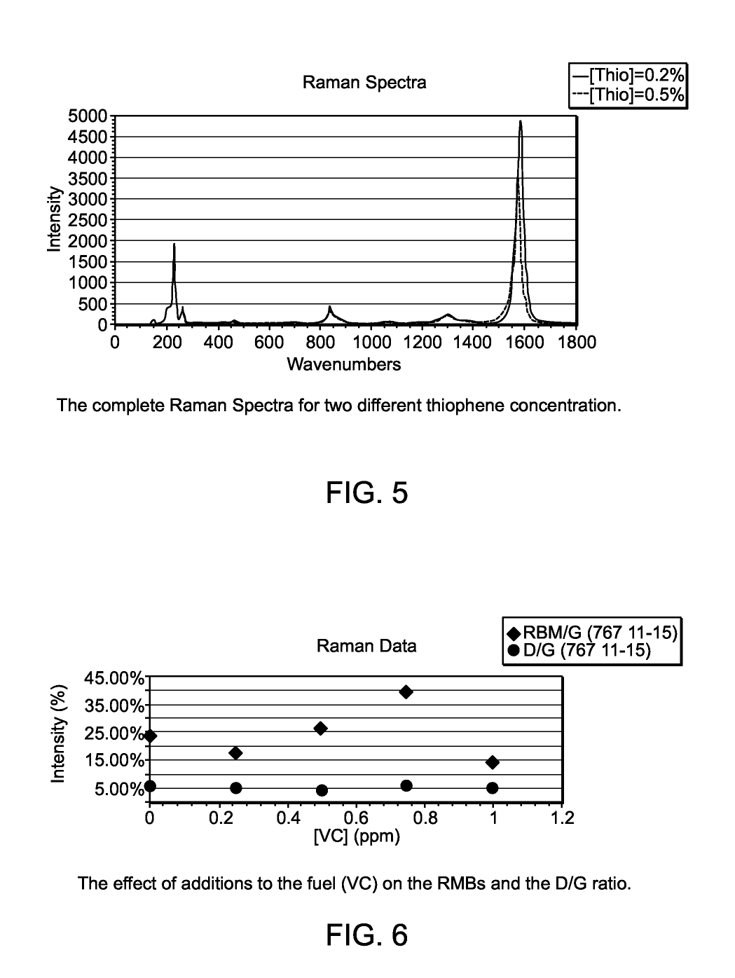

In one embodiment, as shown in FIG. 7, the ratio of Hydrogen flow through the injector to the that in the reactor tube 12, when set at about 100× to about 110× the injection rate for a given set of other parameters, with about 104× being optimal, can enhance growth and production efficiency. It should be appreciated that variations in Hr reflect variations in the ratio of Hr/Hr. Moreover, this ratio can change for different fluid mixture make up.

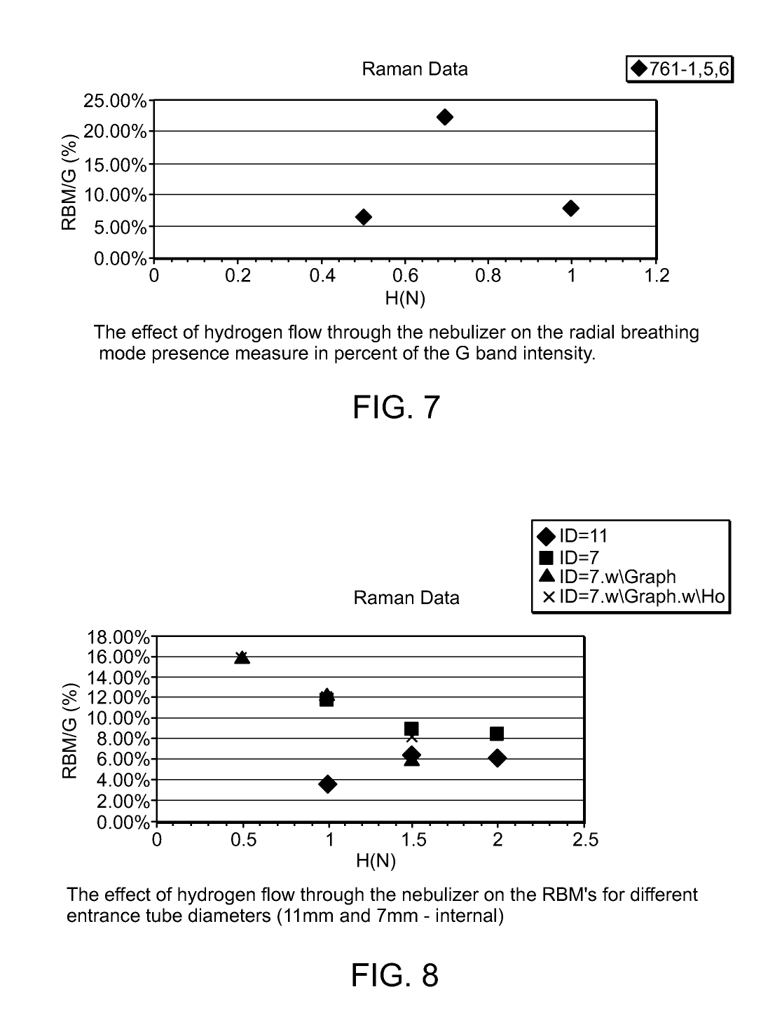

The optimum ratio of Hydrogen flow can also be dependent upon the internal diameter (ID) of the injector tube. As illustrated in FIG. 8, the effect of Hydrogen flow through the injector on the RBMs can differ based on different IDs. The diameter IDs tested in connection with this particular experiment varied between 7 mm and 11 mm. Of course, other diameters can be used.

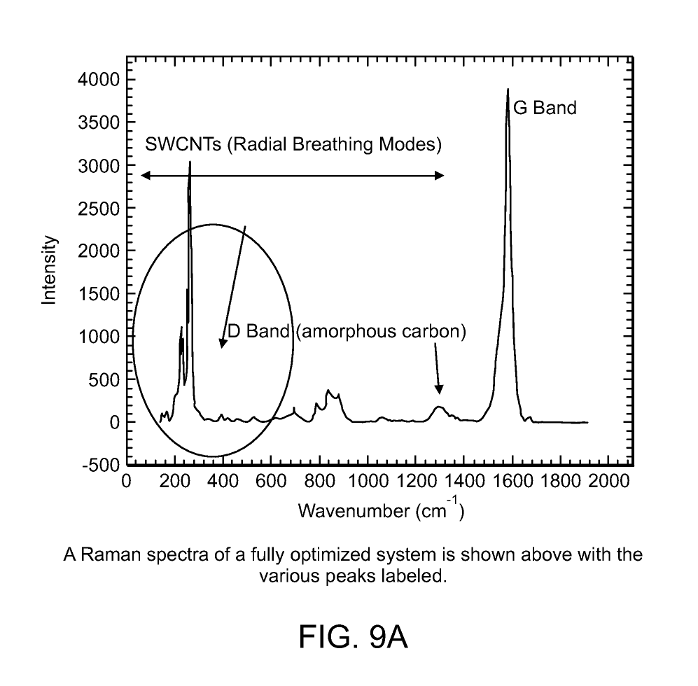

Using the Raman data, these various parameters can be simultaneously optimized to reliably and reproducibly generate carbon nanotubes having a substantially large fraction of SWNTs. A Raman spectra for a substantially optimized system is shown in FIG. 9A. To the extent necessary, these optimum parameters can be modified to accommodate different furnace diameters. In FIG. 9B, an illustration of the RBM region of the spectra shown in FIG. 9A is provided. FIG. 9B essentially provides a histogram of the furnace diameter distribution.

### Experiment IV

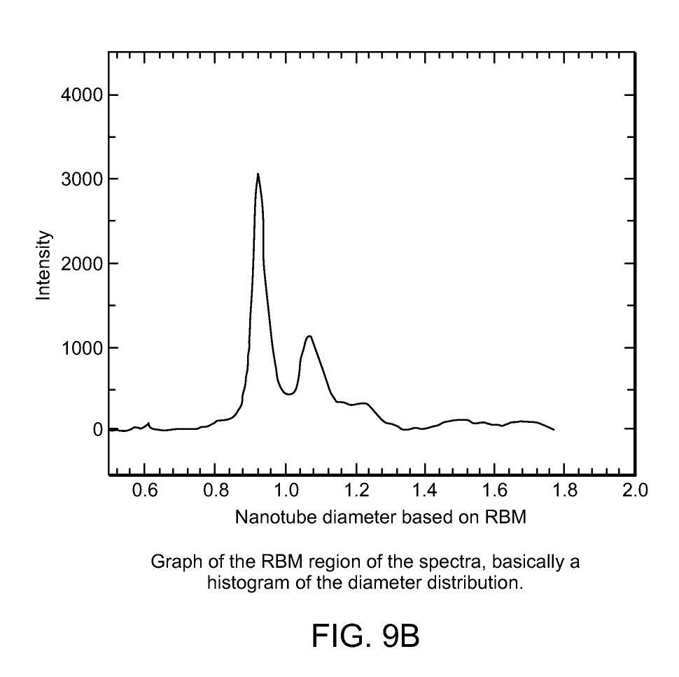

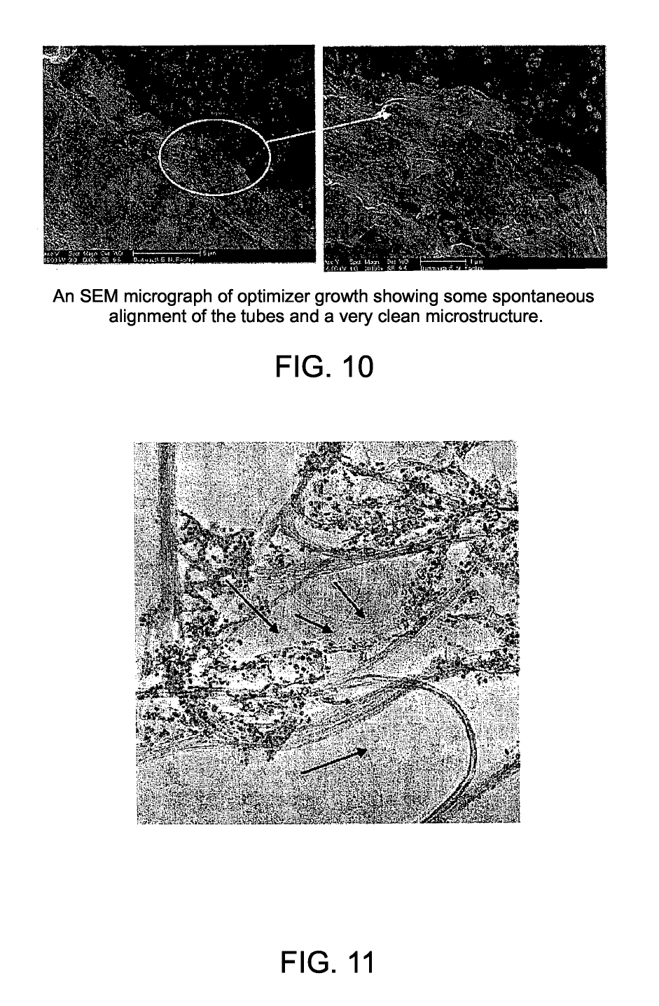

Scanning (SEM) and Transmission Electron Microscopy (TEM) was conducted on nanotubes made from an optimized furnace in system 10 of the present invention. The results from the electron microscopy are shown in FIG. 10 and FIG. 11.

In particular, FIG. 10 illustrates an SEM micrograph of optimized growth showing some spontaneous alignment of the tubes and a substantially clean microstructure. It should be appreciated that no purification was used in connection with this procedure.

FIG. 11, on the other hand, illustrates a TEM micrograph of substantially small nanotubes, ropes made from small nanotubes, larger SWCNTs and an average amount of catalyst, and a minimal amount of amorphous carbon, all of which are consistent with the Raman spectra.

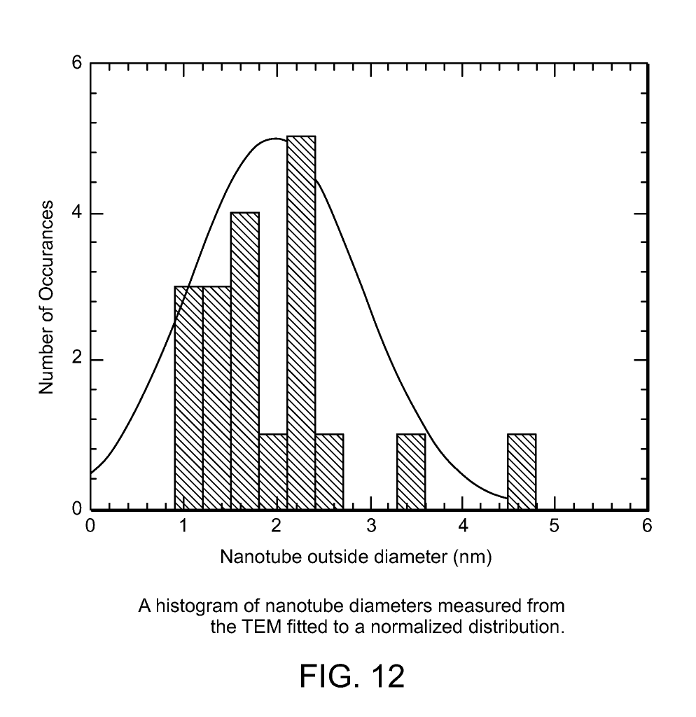

In connection with the electron microscopy, looking now at FIG. 12, a histogram of nanotube diameters measured from the TEM is provided. The histogram, as shown, is fitted to a normalize distribution. It should be noted that since this fit was a force fit, it should not be assumed that the distribution was actually a normal distribution. In fact, it appears to be skewed to the smaller diameters. This is consistent with the Raman data shown in FIG. 9A where the predominant RBMs correspond to the 0.7 nm and 1.0 nm nanotubes.

### DISCUSSION

Based on the experiments performed and the data obtained, a process for generating longer and stronger nanotubes can be provided. It is noted that smaller tubes tend to grow faster. In particular, SWNTs can rope together to form macrostructures, as was shown dramatically in the SEM micrographs above. The roped together SWNTs can transfer load from one nanotube to the next very well. As such, it is expected that small diameter SWNT material can be stronger than larger diameter SWNTs or multi-walled tubes.

Data relating a furnace used in the production of non-woven sheets of nanotubes, and into which the injector of the present invention with optimized configuration was introduced, have shown dramatic increase in textile strength, from about 40 MPa to over 300 MPa. All measurements were made without subsequent processing. In addition, it has been shown that stretching the non-woven sheets of nanotubes can increase the strength anisotropically by a factor of 3, while at the same time reducing electrical resistivity about the same amount ˜3×10−4 ohm-cm.

Moreover, the system and process of the present invention have led to production of textile having strength exceeding 400 MPa in the as deposited state, and 1800 MPa when processed. (measured at a 1 cm gauge length)

The ability to control catalyst size through these experimental parameters opens up many possibilities for tailoring products to applications. Smaller tubes have a much higher surface area per unit mass. This means that specific capacitance should be greatly be increased. Also, smaller CNTs tend to be more reactive. This may enhance the ability to form strong composite materials. In addition, the optimization of specific diameters may allow some chirality selectivity in CNT production. In any case it may be possible to enhance the concentration of either semi-conducting or metallic tubes.

Structures formed from carbon have been discussed herein. However, it should be recognized that nanostructures, including nanotubes, can be formed from other materials, including for example, boron nitride, tungsten sulfide, vanadium oxide, and boron carbon nitride using catalytic processes similar to that described above. Accordingly, the present invention also includes extended-length nanotubes and prismatic nanostructures formed from inorganic materials such as vanadium oxide and boron nitride, and from carbon in combination with other elements, such as boron carbon nitride.

While the invention has been described with reference to particular embodiments, it will be understood by those skilled in the art that various changes may be made and equivalents may be substituted for elements thereof without departing from the scope of the invention. In addition, many modifications may be made to adapt a particular situation or material to the teachings of the invention without departing from the scope of the invention.

What is claimed is:

1. A system for use with a reactor for synthesis of nanostructures, the system comprising:
a chamber defining a pathway for directing a fluid mixture for the synthesis of nanostructures through the chamber;
one or more heating zones disposed along the chamber to provide a temperature gradient in the chamber sufficient to permit the formation, from components within the fluid mixture, of catalyst particles upon which nanostructures can be generated; and
a plasma generator for generating a plasma flame in a conduit, the conduit having an inlet in fluid communication with the pathway of the chamber and an outlet in fluid communication with the reactor to pass the fluid mixture from the pathway, through the plasma flame to decompose a carbon source in the fluid mixture into its constituent atoms and into the reactor for formation of nano structures.

2. The system as set forth in claim 1, wherein the one or more heating zones include a first heater situated downstream of an inlet to the chamber to maintain a temperature range at a level sufficient to decompose, from the components within the mixture, a catalyst precursor to permit subsequent formation of catalyst particles therefrom.

3. The system as set forth in claim 2, wherein the one or more heating zones include a second heater situated downstream of the first heater to maintain a temperature range at a level sufficient to decompose, from the components within the mixture, a conditioning compound for interaction with the catalyst particles in order to control size distribution of the catalyst particles.

4. The system as set forth in claim 1, wherein the plasma generator is a direct current plasma generator.

5. The system as set forth in claim 1, wherein the plasma generator includes a magnetic coil configured to generate an electrostatic field for nanostructure alignment.

6. The system as set forth in claim 1 further comprising a mechanism at a distal end of the chamber to minimize turbulent flow as the fluid mixture exits the chamber.

7. The system as set forth in claim 1 further including insulation about the chamber to maintain a temperature gradient along the pathway of the chamber.

8. The system as set forth in claim 1 further comprising a fluid tight seal between the chamber and the plasma generator.

9. The system as set forth in claim 1, wherein the plasma generator is in coaxial alignment with the chamber.

10. A method for producing nanostructures, the method comprising:
passing a fluid mixture from which carbon nanostructures can be generated through a temperature gradient to initiate the carbon nanostructures generation process;
directing the mixture through a plasma flame to elevate the mixture to a temperature range sufficient to decompose a carbon source in the fluid mixture into its constituent atoms;
permitting the carbon atoms to interact with the catalyst particles to allow growth of nanostructures on the catalyst particles.

11. The method as set forth in claim 10, wherein in the step of passing, the fluid mixture including a catalyst precursor and a conditioning compound is passed through the temperature gradient to decompose the catalyst precursor to permit generation of catalyst particles and to decompose the conditioning compound for subsequent interaction with the catalyst particles to condition the catalyst particles.

12. The method as set forth in claim 11, wherein in the step of passing, the temperature gradient includes a first heating zone to maintain a temperature range at a level sufficient to decompose, from the components within the mixture, a catalyst precursor to permit subsequent formation of catalyst particles therefrom and a second heating zone downstream of the first heating zone to maintain a temperature range at a level sufficient to decompose, from the components within the mixture, a conditioning compound for interaction with the catalyst particles in order to control size distribution of the catalyst particles.

13. The method as set forth in claim 10, wherein in the step of directing, the plasma flame is generated by a direct current plasma generator.

14. The method as set forth in claim 10 further comprising maintaining a laminar flow of the fluid mixture during the growth of nanostructures.

15. The method as set forth in claim 10 further comprising generating an electrostatic field to align nanostructures.

16. The method as set forth in claim 10 further comprising generating an electrostatic field to condense the nanostructures toward a filament like shape.

17. A system for synthesis of nanostructures, the system including:
a housing having opposite ends and a passageway extending between the ends;
a conduit having an inlet and an outlet, the outlet of the conduit being in fluid communication with a first end of the passageway;
an injector for introducing a fluid mixture having a catalyst precursor and a carbon source into the inlet of the conduit;
one or more heating zones along the injector to provide a temperature range sufficient to decompose catalyst precursor to form catalyst particles upon which nanostructures can be generated within the injector;
a plasma generator adapted to generate a plasma flame in the conduit to elevate the fluid mixture to a temperature range sufficient to decompose carbon source in the fluid mixture into its constituent atoms for formation of nanostructures on the catalyst particles; and
a collector in communication with a second end of the housing for collecting synthesized nanostructures.

18. The system as set forth in claim 16, wherein the one or more heating zones include a first heater situated downstream of an inlet to the chamber to maintain a temperature range at a level sufficient to decompose, from the components within the mixture, a catalyst precursor to permit subsequent formation of catalyst particles therefrom and a second heater situated downstream of the first heater to maintain a temperature range at a level sufficient to decompose, from the components within the mixture, a conditioning compound for interaction with the catalyst particles in order to control size distribution of the catalyst particles.

19. The system as set forth in claim 16, wherein the plasma generator is a direct current plasma generator.

20. The system as set forth in claim 16, wherein the plasma generator includes a magnetic coil configured to generate an electrostatic field for nanostructure alignment.
